(19) United States
(12) Patent Application Publication
(10) Pub. No.: US 2011/0078569 A1
(43) Pub. Date: Mar. 31, 2011

(54) VALUE HELP USER INTERFACE SYSTEM AND METHOD

(75) Inventors: Robert Lorch, Dossenheim (DE); Frederik Thormaehlen, Mannheim (DE)

(73) Assignee: SAP AG

(21) Appl. No.: 12/569,788

(22) Filed: Sep. 29, 2009

(51) Int. Cl. G06F 17/30; G06F 3/01; G06F 3/048

(52) U.S. Cl. 715/708; 707/769; 715/810; 707/E17.044

(57) ABSTRACT

A computer-implemented method providing value help user interface for an underlying application where a request for field names associated with at least one value help backend system is sent by a server. The server may receive the field names from the backend system and display the field names in a user interface and provide filter criteria for each field for the user. The user may enter the search and filter criteria and the user interface may be configured to receive the filter criteria from the user. The search request may be sent to a value help service. The value help service may prompt the back end system to run a search and in turn receive results from the back end system that includes data and metadata. The metadata may describe the format of the search results. The data may be passed according to the metadata and a search results may be generated for the user. The user may make a selection from the search results and the selected data my be delivered to an underlying application.

### BACKGROUND

Service oriented architecture (SOA) may provide various application logics in services with a uniformly defined interface and making these services publicly available via discovery mechanisms. The architecture may provide access to various services through an interface designed by an application developer. SOA applications may send messages as the basic unit of communication. SOA applications may be a composite of various integrated services, that can be individually modified without affecting the performance of other services. Since SOA may be structured to be platform independent, SOA implemented architecture allows for greater interoperability between different platforms. In SOA applications, as in other architecture, there is often a need to provide value help functionality that provides help to users entering values in a graphical user interface.

### SUMMARY

A computer-implemented method providing value help user interface for an underlying application where a request for field names associated with at least one value help backend system is sent by a server. The server may receive the field names from the backend system and display the field names in a user interface and provide filter criteria for each field for the user. The user may enter the search and filter criteria and the user interface may be configured to receive the filter criteria from the user. The search request may be sent to a value help service. The value help service may prompt the back end system to run a search and in turn receive results from the back end system that includes data and metadata. The metadata may describe the format of the search results. The data may be passed according to the metadata and a search results may be generated for the user. The user may make a selection from the search results and the selected data my be delivered to an underlying application.

### BRIEF DESCRIPTION OF THE DRAWINGS

FIG. 1 is a schematic diagram of an enterprise system according to an embodiment of the present invention.

FIG. 2 is an example process that may be implemented using the system shown in FIG. 1.

FIG. 3 shows an example representation of data that may be received when the back end system is queried a first time to form a user interface.

FIG. 4a is a screen display that may be shown to a user when the user requests value help.

FIG. 4b is a screen display that may be shown to the user when the user enters search and filter criteria for at lease one field.

FIG. 5 shows example metadata and result data that may be returned as a search perform by a backend system.

FIG. 6 is a screen display that may be shown to the user when the user requests value help.

### DETAILED DESCRIPTION OF THE DISCLOSURE

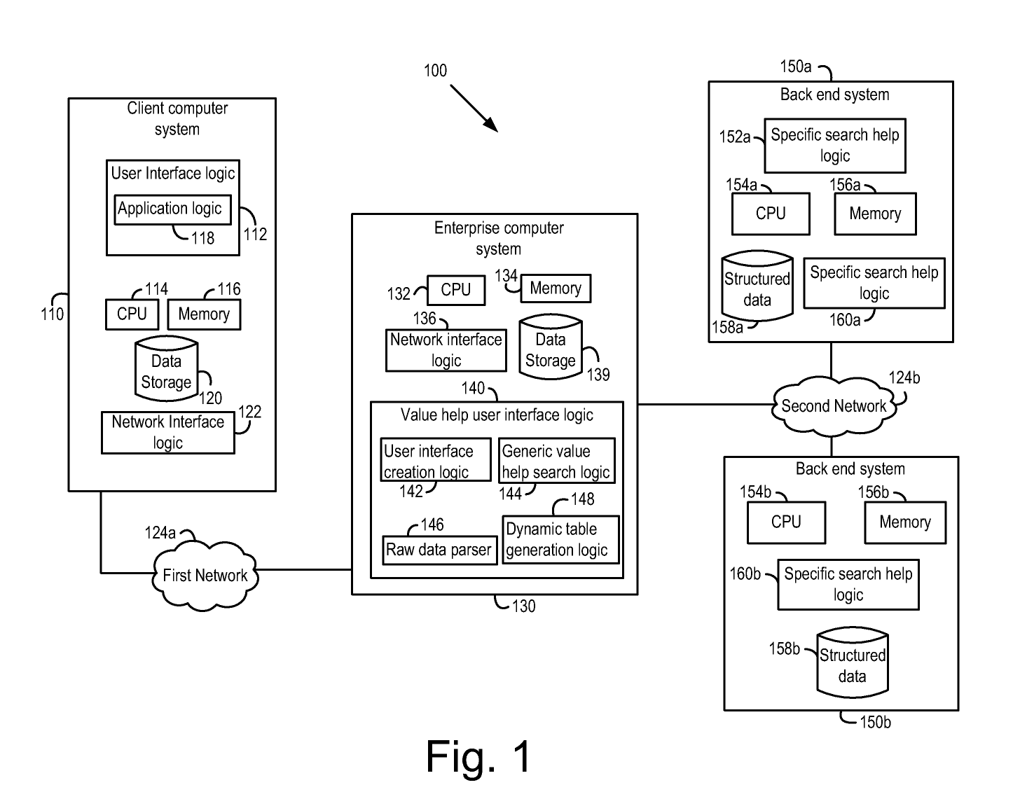

Referring to FIG. 1, FIG. 1 shows a schematic diagram of a system 100 according to an example embodiment of the present invention. The system 100 may include a client computer system 110, first network 124a, second network 124b, enterprise computer system 130, back end system 150a and back end system 150b. In an example embodiment, the client computer system 110, enterprise computer system 130 and the back end systems 150a and 150b may be several computing systems that may be connected via a network. Similarly, in another example embodiment, the enterprise computer system 130 and the back end system 150a and 150b may be implemented on a single computing system.

The client computer system 110 may include, among other systems, a user interface logic 112, central processing unit (CPU) 114, memory 116, application logic 118, data storage 120 and a network interface logic 122. The client computer system 110 may include a computing system, for example, comprising one or more networked computers that are programmed to perform the various operations described herein. These functions include generating a user interface, and/or sending search criteria to the enterprise computer system 130 by using the network interface logic 122. These operations may further include, processing the response received from the enterprise computer system 130 and displaying the values for the user or updating the data storage 120. The user interface logic 112 (e.g., a web browser, an application program, etc.) may be configured to receive user interface information from the enterprise computer system 130. The user interface logic 112 may be configured to present user interfaces (e.g., screen displays) based on the information received from the enterprise computer system 130 which includes information received from a value help user interface logic 140. The user interface logic 112 may receive input from the user (e.g., in the form of a mouse and/or a keyboard) and send the received information to value help user interface logic 140 as search criteria. In another embodiment, other electronically interactive devices may be utilized. The CPU 114 may be used to process and/or compute instructions and manipulate data. The CPU 114 may be formed using multiple processor or a single processor. The memory 116 and data storage 120 may be used primarily to store data for CPU 114.

Network interface logic 122 may facilitate communication between the enterprise computer system 130, the first network 124a and the back end systems 150a and 150b. The network interface logic 122 permits the client computer system 110 and enterprise computer system 130 to connect to each other and/or other computer systems. Network interface logic 122 may also comprise other logic that may be configured to provide an interface for other types of devices, e.g., if the client computer system is another type of device such as a cell phone, smart phone, mobile e-mail device, other server-based computing device, and so on.

In an example embodiment, the enterprise computer system 130, back end systems 150a and 150b, may be provided by a software company. In another embodiment, the enterprise computer system 130 and the client computer system 110 may be provided by an entity that uses software provided by a software company. Likewise, other combinations are also possible.

In an example embodiment, the enterprise computer system 130 may include a central processing unit (CPU) 132, memory 134, network interface logic 136, data storage 139 and value help user interface logic 140. Such logics may be implemented in a machine (e.g., one or more servers and other computers) comprising machine-readable storage media (i.e. cache, memory, flash drive or internal or external hard drive or in a cloud computing environment) having instructions stored therein which are executed by the machine to perform the operations described herein. The enterprise computing system 130 may be an implementation of a service oriented architecture comprising various interoperable services that each perform distinct functions.

The value help user interface logic 140 may include user interface creation logic 142, generic value help search logic 144, raw data parser 146 and dynamic table generation logic 148. Each of the above systems, may be implemented on the enterprise computer system 130 or one or more of the above systems may be partially or in whole implemented on the client computer system 110 or other computer systems.

The value help user interface logic 140 provides an output to the user to provide access to the value help source searches 152a, 160a, and 160b. Value help may aid the user in selecting appropriate values when completing the fields or objects provided by application logic 118. For example, if the user does not know what the appropriate value for a particular field may be, the user may click on a value help button in the application. In response, the value help user interface logic 140 may display various user interfaces in order to help the user select the appropriate value. For example, the user interfaces may provide a search filter and receive user selected search and filter criteria. The value help user interface logic 140 may also communicate with remote backend systems 150a and 150b and receive structured data from the remote backend system 150a and 150b in order to allow the user of the application logic 118 to select the appropriate value.

The value help user interface logic 140 may allow a user to access pre-existing (e.g. legacy) search tools of the back end systems 150a and 150b via the user interface created by the user interface creation logic 142. For example, an application developer may wish to provide a value help search for a user relating to various fields in a form or program code. The value help user interface logic 140 may allow the developer to utilize search tools that preexist in the back end systems 150a and 150b. The value help user interface logic 140 may be one of the services in the service oriented architecture implemented by the enterprise computing system 130. Multiple instances of the value help user interface logic 140 may be initialized in the enterprise computer system 130 using the application logic 118 from the client computer system 110, as needed.

In order to use a pre-existing searches in the back end systems 150a and 150b, the developer of the application logic 118 may know the name of the pre-existing value help search and/or the specific search help logic 152a, 160a and 160b implemented in the back end systems 150a and 150b, respectively. In one example, a first application may use all value help from backend system 150a and a second application may use all value help from backend system 150b. In this example, the registration table may include a column that identifies the back end system by a backend identification number. In yet anther example embodiment, a first application may use some value helps from backend system 150a (e.g. business partner names) and some value help from backend system 150b (e.g. geographical data). The backend identification column in the registration table would help implement this functionality as well. In a third example, a first application may use the values from one value help (e.g. business partner) from backend system 150a and from backend system 150b and then a merged value help is shown by the value help application. In this third example, the data from back end system 150a and 150b may be shown as a single value help user interface. Such information may be stored in a registration table contained in the application logic 118. The registration table may be responsible for the communication between the application logic 118 and the user interface creation logic 142 of the value help user interface logic 140. The registration table may be used to store all relevant information about the registered application data and the assigned value help information. An example of such a registration table is shown below:

Registration Table

| | Value | | Value | | Application | Application | |
|---|---|---|---|---|---|---|---|
| Custom Application | Help | Return | Help | | Window | Data | Filter |
| Data | Name | Field | Group | ScreenId | instance | pointer | ID |
| EmployeeName | PREMK | ENAME | MyBP1 | CustomerView | <window | <data | 100 |
| | | | | | pointer 1> | pointer1> | |
| EmployeeID | PREMK | PERNR | MyBP1 | CustomerView | <window | <data | |
| | | | | | pointer 1> | pointer2> | |
| EmployeeCostCenter | PREMK | KOSTL | MyBP1 | CustomerView | <window | <data | |
| | | | | | pointer 1> | pointer3> | |
| Sales Order ID | H_TVKO | | | SalesOrderView | <window | <data | |
| | | | | | pointer 1> | pointer4> | |
| Sales Order Name | H_TVKO | | | SalesOrderView | <window | <data | |
| | | | | | pointer 1> | pointer5> | |

In other embodiments, in order to populate the registration table, the developer of the generic help search interface 118 may request the enterprise computer system 130 to perform a search in various backend systems and determine the name of the pre-existing value help search from the back end systems 150a and 150b.

The user interface creation logic 142 may generate a request for a particular field associated with a specific value help logic. For example, as shown above for the application field “EmployeeName” the value help name is “PREMK” and the particular field associated with the value help “PREMK” is “ENAME.” As another example, the user interface creation logic 142 may produce a pull down or complex popup menu for the user of the application logic 118. In case of the pull down menu, the user may be provided with all of the available choices. In yet another example, the user interface creation logic 142 may generate a complex popup window with filter criteria or search options. The interface creation logic 142 may also generate customized options for showing key-value pairs in a dropdown menu instead just providing the values to choose. The interface creation logic 142 may be configured by the developer of the application logic 118 to use one value help search for one user interface field.

The interface creation logic 142 may provide a customized input according to the system being configured to have users with more privileges and other users with less privileges. In another embodiment, the user interface creation logic 142 may be configured to cause multiple user interface fields to receive input from one value help when each user interface field uses the same value help search. Essentially, this allows the user to make one selection and populate the other related fields. The user interface creation logic 142 may also provide hierarchical or multi-level value helps. The user interface creation logic 142 may also provide a pre-filtering option in the application logic 118. Pre-filtering option may show the user a filtered selection of values for one value help (e.g., when a country is selected, only regions inside that country are shown in the regions field). The user interface creation logic 142 may also assign one user interface field to multiple value help, such that the user interface logic 142 allows the user to select one of the value helps when the user requests the value help. Thus, there may be more than one value help for one field.

After receiving the name of the search to run, and the search criteria, the generic value help search logic 144 may process the search and the search criteria provided by the user and send it to the appropriate back end system. The search help logic 152a, 160a, 160b (e.g., legacy search tools) of the back end systems need not be configured as services in the service oriented architecture implemented by the enterprise computing system 130. The generic value help search logic 144 provides a SOA interface to the search help logic 152a, 160a, 160b for other services and components of the enterprise computing system 130. The search help logic 152a, 160a, 160b may perform the search, generate metadata and data which may be sent to the enterprise computer system 130 for further processing, if necessary, or the results may be displayed on the user's screen.

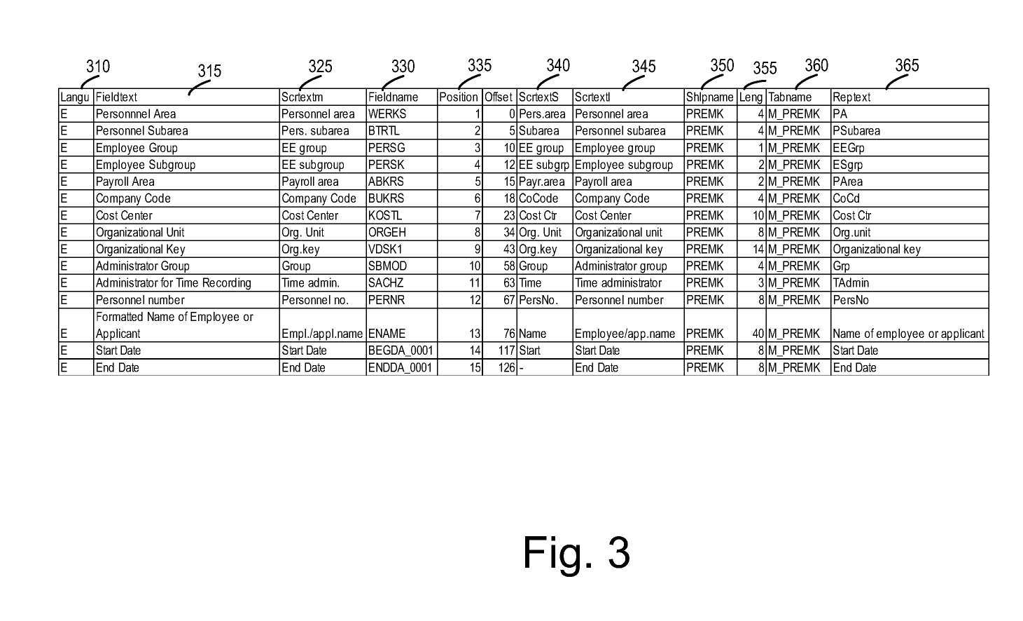

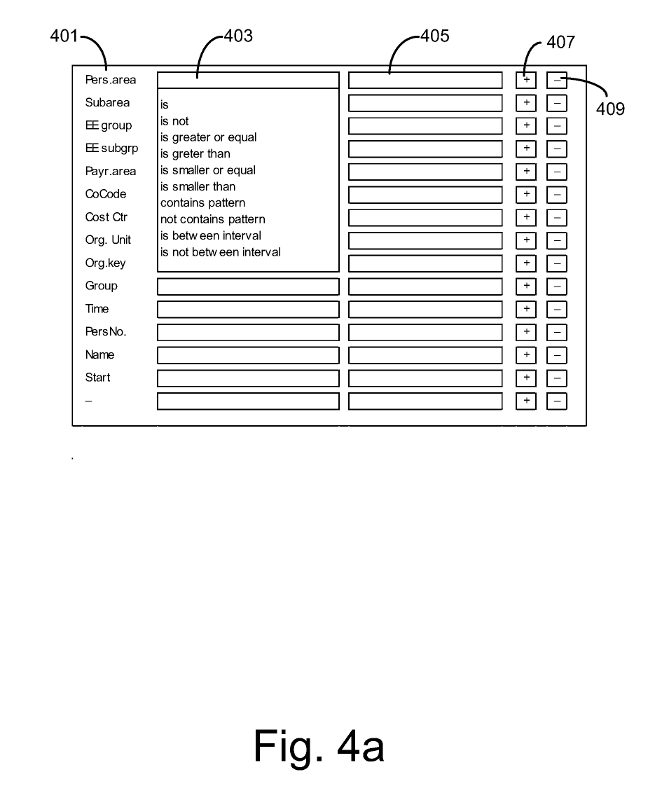

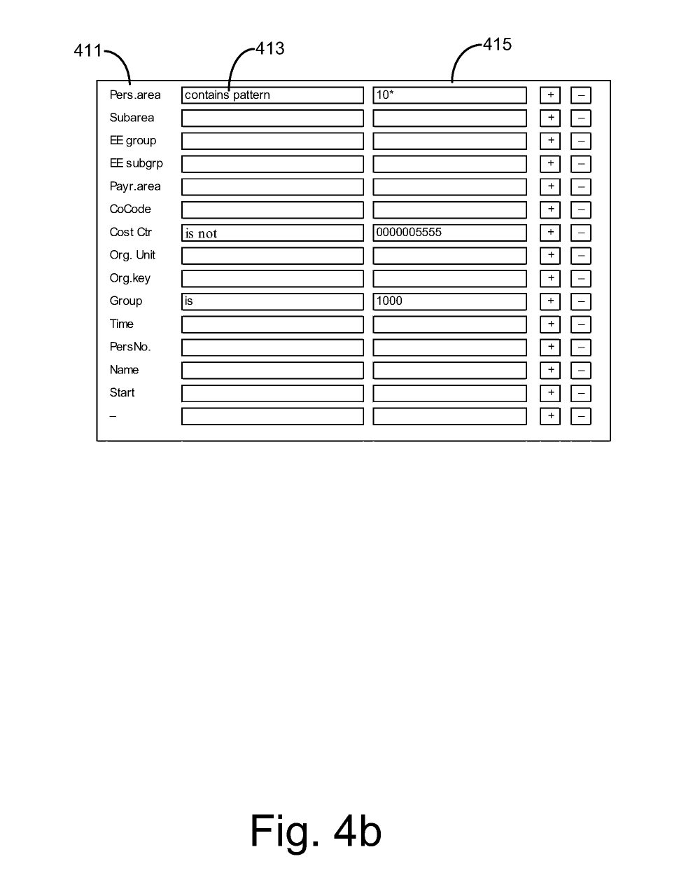

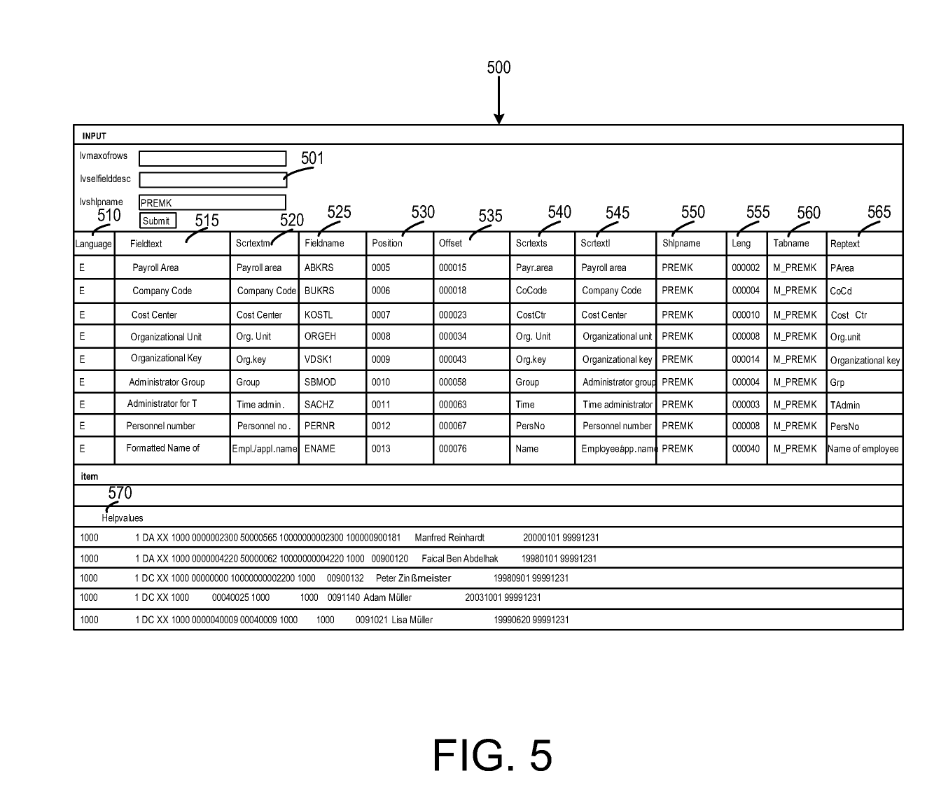

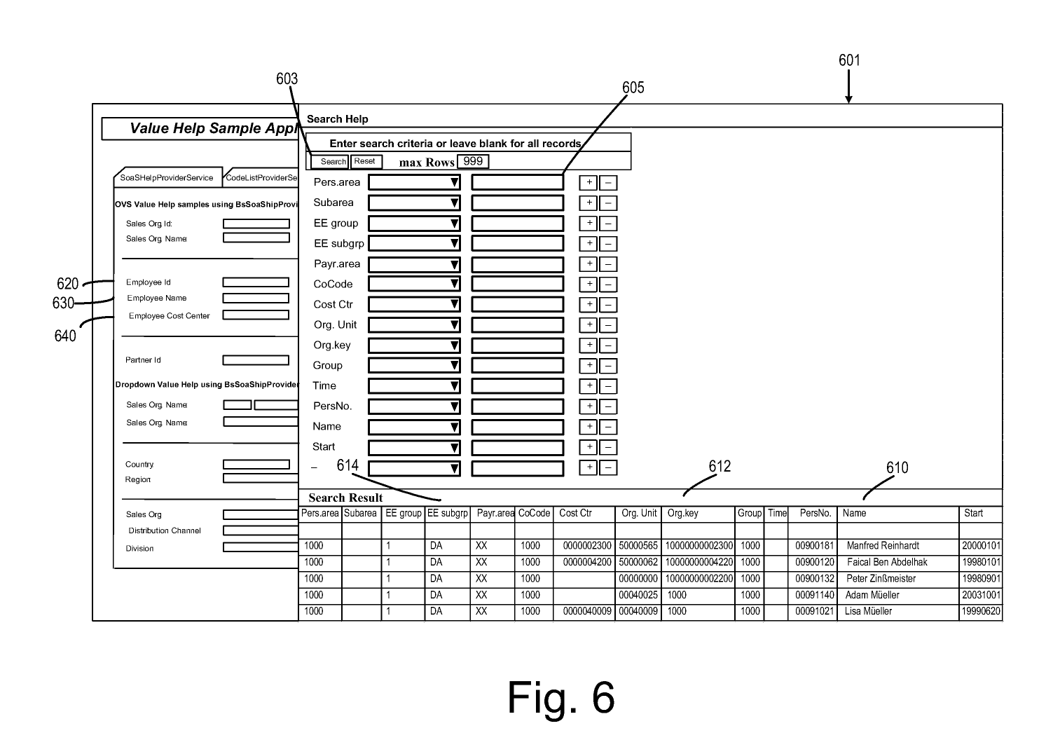

The raw data parser 146 may receive search results data and metadata. The metadata is data that describes the structure of the search results data. The raw data parser 146 may correlate the columns of the metadata that are informative regarding position of a particular field, the number of characters in the field, the offset of the field to form a results output (i.e., results table). Portions of data receive may be a string of binary, hexadecimal, or alpha numeric characters. The data may be parsed and placed in a displayable format (i.e., results table) by the raw data parser 146 to assemble a table as shown in FIGS. 5-6. Metadata, as shown in FIG. 3, received as a result of a first query to a backend system may be used to generate a screen as shown in FIG. 4a. For example, with regard to FIG. 3 the “Fieldtext” column 315 may be used to generate at least a portion of FIG. 4a.

Once the data has been parsed by the raw data parser 146 the data may be forwarded to the dynamic table generation logic 148, which creates the results table using the data format received from the parser. The dynamic table generation logic 148 may create a results table that may be filtered further according to the user input. For example, any field that is displayed in the results table may be sorted alphabetically or numerically upon receiving appropriate user input. The dynamic results table may be generated from the parsed results table provided by the data parser 146.

Also shown in FIG. 1 is the second network 124b used to communicate with a plurality of back end systems 150a and 150b. Each back end system 150a and 150b may have varying designs. In particular, the back end system 150a may have a plurality of specific search help logics 152a and 160a. The back end systems 150a and 150b may store data in a structured format such as a relational database or other structured data. When using the client computer system 110, the user may enter data in a structured form stored in the structured data 158a and 158b, thereby allowing for faster more accurate searches. However, each backend system 150a and 150b may return search results in a different format. Thus, the generic value help search logic 144 receives both a concatenated string of search results data and meta data which may be used to reconstruct the structure of the search results data.

The back end systems 150a and 150b include a CPU 154a and 154b. These CPUs may be a single or plurality of networked processors. Similarly, the back end systems 150a and 150b include memory 156a and 156b, respectively. As described above, the structured data 158a and 158b can be queried by the enterprise computer system 130. Upon receiving a query or search request, the back end systems 150a and 150b may return among other things, a table with the metadata for the selection screen to permit further search criteria to be specified (see FIGS. 3-4b) or the metadata and the search results data (see FIGS. 5-6). Moreover, the client computer system 110 is configured to receive the search criteria, and display the search criteria. However, the enterprise computer system 130 may be configured to receive information from the client computer system 110 and to receive information from the back end systems 150a and 150b. Although only two backend systems 150a and 150b are shown, it will be appreciated that the enterprise computer system 130 may comprise any number of such backend systems with any number of specific search logics within them.

The generic value help search logic 148 provides a generic interface that need not be modified for each value help button even though each button may trigger accessing of different specific backend search tools 152a, 160a, 160b. Moreover, the generic value help search logic 148 uses the pre-existing back end system and searches, which allows the generic value help search to leverage previous back end system solutions. In the architecture shown in FIG. 1, searching tasks are completed by the back end systems 150a and 150b and the processing of the search results to generate a data display may be performed by the enterprise computer system 130. Thus, the client computer system 110 does not have to perform searches or gather the results directly from the back end systems 150a and 150b.

The user interface creation logic 142 provides a generic tool for dynamically creating value help user interfaces. The developer of the underlying application may, for example, write a single line of code that provides the search help name and the field being searched in the value help. The multi-level hierarchical user interface is provided by the value help user interface logic 140. Also provided is the raw data parser 146 and the dynamic table generation logic 148, thus the developer of the front end user interface does not have to create a new user interface for each value help call.

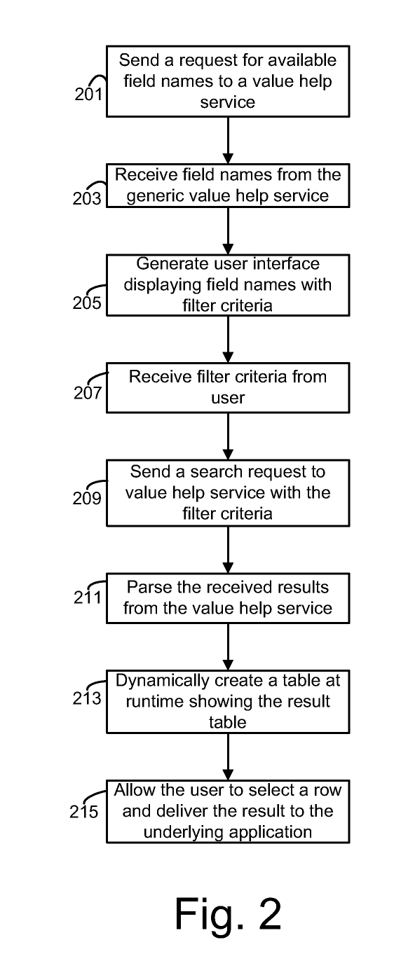

Referring to FIG. 2, FIG. 2 is an example process that may be implemented using the system shown in FIG. 1. FIG. 2 shows a process in which the backend system is queried twice. The first query obtains metadata to build a search filter that permits further search criteria to be specified by the user (see FIGS. 3-4b). The second query obtains value help search results including metadata and result data to assemble a search result table. At step 201, the client computer system 130 may send a request for available field names to a value help service. At step 203, field names are received from the generic value help service. At step 205, the user interface creation logic 142 may generate a user interface displaying field names with filter criteria to the user requesting input of filter and search criteria. At step 207, the user interface creation logic 142 may receive the filter and search criteria entered by the user. At step 209, the user interface creation logic 142 may send a search request to the generic value help search logic 144 with the filter criteria. At step 211, the raw data parser may receive the metadata and the raw data and parse the received results to form a table. At step 213, a dynamic results table may be created by the dynamic table generation logic 148. At step 215, the user may select at least one value from the dynamic results table and the selected results may be delivered to the underlying application. The steps of FIG. 2 are discussed further below in connection with FIGS. 3-6.

Referring now to FIGS. 3, 4a, and 4b, FIG. 3 shows an example data table that may be provided by one of the back end systems 150a and 150b (at step 203) after the back end system is queried the first time. The table in FIG. 3 is used (at step 205) to build a field name user interface in FIG. 4. Certain fields or columns such as column 325 “Scrtxtm” may be used to create a user interface list each of the field that may be searched for the value help. For example, in FIG. 4a, the words listed in column 325 may be listed as the field name.

As shown in FIG. 4a, the screen display can be a pop window or a screen that changes the flow of the underlying application. The screen offers the user the opportunity to enter a search criteria for each of the fields shown the field name column 401. The first filter field 403 provides the user with the predetermined filter criteria. The first filter field 403 allows the user to choose various filter parameters. Parameters such as but not limited to, equal to, not equal to, greater than/equal to, greater than, less than/equal to, less than, contains pattern, not contains pattern, between interval, and not between interval may be used by the user. Other options may be offered. For example, when entering the search criteria, the user may be given the choice of limiting the number of results generated or may be given the ability to choose to receive the metadata prior to seeing the results. A text box 405 may allow the user to enter search criteria. In other embodiments, one text box may be presented, similarly, in other embodiments two or more text boxes may be presented. Once the user has input the search criteria, the user can choose the submit the filter/search request. Upon submitting the search request, the client computer system 110 may send the value help search criteria to the enterprise computer system 130. The enterprise computer system 130 may receive the search request and identify the back end system that is configured to perform the search. In an example embodiment, the developer of the application logic 118 may specify which particular search to use in connection with a given type of value help search.

Referring to FIG. 4b, FIG. 4b is a screen display that may be shown to the user when the user enters various search criteria, at step 207. For example the user has chosen the filter criteria “contains pattern” 413 and the pattern is “10*” where the * is the wildcard, as shown in field 415. Also shown is the cost center field name with a filter criteria “is not” and in the related text box the cost center number “0000005555” is shown.

Referring to FIG. 5, FIG. 5 shows example metadata and the result data that may be returned as a search perform by a backend system in response to the second query of the backend system (steps 209-211). Value help 501 named “PREMK” was searched in the back end system. The table shown in FIG. 5 shows the metadata and the results 570. The metadata includes various fields that allow an enterprise computer system 130 to create a table for the user using results 570 and the metadata. The first column may be language 510, as shown in this example the language is E used for English. Field text 515 stores the text of that should be displayed for each field. Also shown in FIG. 5 is the position 530, offset 535 and the length 555 which may allow the enterprise computer system 130 place the data from the results 570 in the correct location in the table that may be displayed to the user. The results 570 may be a concatenated string of characters that can be displayed in a structured data format of a table. However, in order to display the concatenated string of characters in a structured format the enterprise computer system 130 may use the metadata shown in FIG. 5. The use of the metadata may allow the embodiments of the generic value help search service 148 to implement a generic value help search.

Referring to FIG. 6, FIG. 6 is a screen display that may be generated by the value help user interface logic 140 (step 213) for presentation to the user. As shown in FIG. 6, the user has not entered a search criteria in the text box 605 provided by the value help search service. Instead, the user selected search button 603 causing the enterprise computer system 130 to send a request to the backend system and return a set of results. The screen display of FIG. 5 shows the metadata 510 to 565 and the result data 570 that may be used to generate the result table shown in FIG. 6. In particular the rows of the field text 515 or scrtextm 550 metadata may be used as the columns of the search result. Also the result data 570 is used as the column entries, for example the first entry “Manfred Feinhardt”, is shown as the first entry under name 510 column. FIG. 6 allows the user to choose one of the search entries and the help search interface 118 enters each of the employee Id 620, employee name 630 and employee cost center 640 into each respective field. Thus, the system 100 as allows the user to enter information regarding a particular set of logically related fields (i.e. 620, 630 and 640) by selecting one of the search results.

The embodiments of the present invention have been described with reference to drawings. The drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products or logics comprising machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, CD-ROM or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing computers in the form of computers, including a processing unit, a system memory or database, and a system bus that couples various system components including the system memory to the processing unit. The database or system memory may include read only memory (ROM) and random access memory (RAM). The database may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. User interfaces, as described herein may include a computer with monitor, keyboard, a keypad, a mouse, joystick or other input devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention.

Throughout the specification, numerous advantages of the exemplary embodiments have been identified. It will be understood of course that it is possible to employ the teachings herein without necessarily achieving the same advantages. Additionally, although many features have been described in the context of a particular data processing unit, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The invention is not limited to a particular embodiment, but extends to various modifications, combinations, and permutations that nevertheless fall within the scope and spirit of the appended claims.

What is claimed is:

1. A computer-implemented method for providing value help to a software application, comprising:
sending a request for field names associated with at least one value help to a backend system;
receiving the field names from the backend system;
generating a first display that includes the field names in a user interface with filter criteria for each field name;
receiving filter criteria from a user;
sending a search request to the backend system having the filter criteria;
receiving results from the backend system responsive to the search request, the results including metadata and data;
parsing the data according to metadata;
generating search results from data and the metadata;
generating a second display that includes the data, the data being formatted in the second display in accordance with the metadata;
receiving a selection from a user and delivering the data from the selection to the application.

2. The method of claim 1, wherein the delivering the data from the selection includes delivering data for a plurality of fields in the underlying application.

3. The method of claim 1, wherein the method is performed by value help user interface logic implemented in a server system.

4. The method of claim 1, wherein the server system implements a service oriented architecture, and wherein the value help user interface logic is provided as a service in the service oriented architecture.

5. The method of claim 1, wherein generating the search results comprises receiving metadata regarding the format of the results table.

6. The method of claim 1, wherein the parsing further comprises generating a results table comprises correlating the metadata to a the result table data.

7. The method of claim 1, further comprising receiving a selection of a presentation layout from the user.

8. The method of claim 1, further comprising assigning more than one value help to one user interface field.

9. A computer-implemented method for a user interface for a value help service, comprising:
receiving a name of a value help tool and a field name from a software application;
sending a first request for metadata related to the field to the value help tool;
receiving the requested metadata;
generating a user interface displaying searchable field names based on the received metadata, the user interface requesting filter parameters and search criteria;
sending the received filter parameters and search criteria to the value help tool;
processing the data and metadata received from the value help tool;
displaying a results for a user and receiving a selection from the user; and
delivering the value from the field to the application.

10. The method of claim 9, wherein the value help tool accesses a backend computer system.

11. The method of claim 9, wherein delivering the value includes populating the field associated with the value help tool.

12. The method of claim 9, wherein processing the data and metadata comprises generating a dynamic results table by parsing data and metadata received from the value help tool.

13. The method of claim 12, wherein generating the dynamic results table comprises generating the results table by correlating rows of the metadata to a column in the results.

14. The method of claim 13, wherein generating the results table includes parsing the data and according to the metadata such that the metadata specifies how many characters in the data belong in a particular field in the results table.

15. A value help user interface system comprising:
a user interface creation logic configured to generate a user interface with field names received from a value help search;
a raw data parser configured to parse data according to metadata received from a backend system;
a dynamic table generation logic configured to generate a results table by correlating data in the metadata to a field data in the result table, the user interface logic configured to receive user input of a selection of data in an application field.

16. The system of claim 15, wherein the user interface logic delivers the data includes populating the user interface fields that are assigned to the same value help search.
